(19) United States
(12) Patent Application Publication
(10) Pub. No.: US 2015/0262339 A1
(43) Pub. Date: Sep. 17, 2015

(54) IMAGE PROCESSING APPARATUS, IMAGE PROCESSING SYSTEM, AND IMAGE PROCESSING METHOD

(71) Applicant: KABUSHIKI KAISHA TOSHIBA, Tokyo (JP)

(72) Inventor: Tatsuya MORI, Arakawa Tokyo (JP)

(21) Appl. No.: 14/473,958

(22) Filed: Aug. 29, 2014

(30) Foreign Application Priority Data
Mar. 13, 2014 (JP) 2014-050873

(51) Int. Cl. G06T 5/00

(52) U.S. Cl. CPC G06T 5/002

(57) ABSTRACT

According to an embodiment, an image processing apparatus configured to perform noise reduction of a first image obtained by capturing an object by an image capturing device, includes an intensity setting unit and a noise reduction unit. The intensity setting unit is configured to set intensity of noise reduction based on a focus position of the image capturing device during capturing of the object and an object distance between the image capturing device and the object. The noise reduction unit is configured to perform noise reduction of the first image with the set intensity of the noise reduction.

### CROSS REFERENCE TO RELATED APPLICATION

This application is based upon and claims the benefit of priority from the prior Japanese Patent Application No. 2014-050873 filed on Mar. 13, 2014 in Japan, the entire contents of which are incorporated herein by reference.

### FIELD

Embodiments described herein relate generally to an image processing apparatus, an image processing system, and an image processing method.

### BACKGROUND

When an object is captured by a camera, noise may occur in a captured image. It is desired to reduce such noise from the captured image. In particular, when noise is present in pixels which are out of focus, such noise easily stands out and noise reduction has to be performed with a strong intensity against such pixels. If, however, such a strong intensity noise reduction is performed for pixels which are in focus, an image might be blurred.

### BRIEF DESCRIPTION OF THE DRAWINGS

FIG. 1 is a block diagram of an image processing apparatus 100 according to a first embodiment.

FIG. 2 is a block diagram illustrating an example of an image processing system including the image processing apparatus 100.

FIG. 3 is an explanatory diagram illustrating how a noise reduction is performed using a median filter.

FIG. 4 is a block diagram illustrating an image processing system according to a second embodiment.

FIG. 5 is an explanatory view illustrating a processing in an object distance calculating unit 3.

FIG. 6 is a block diagram illustrating an image processing apparatus 100b according to a third embodiment.

### DETAILED DESCRIPTION

According to an embodiment, an image processing apparatus configured to perform noise reduction of a first image obtained by capturing an object by an image capturing device, includes an intensity setting unit and a noise reduction unit. The intensity setting unit is configured to set intensity of noise reduction based on a focus position of the image capturing device during capturing of the object and an object distance between the image capturing device and the object. The noise reduction unit is configured to perform noise reduction of the first image with the set intensity of the noise reduction.

In the following, embodiments of the present invention will be described specifically with reference to the accompanying drawings.

### FIRST EMBODIMENT

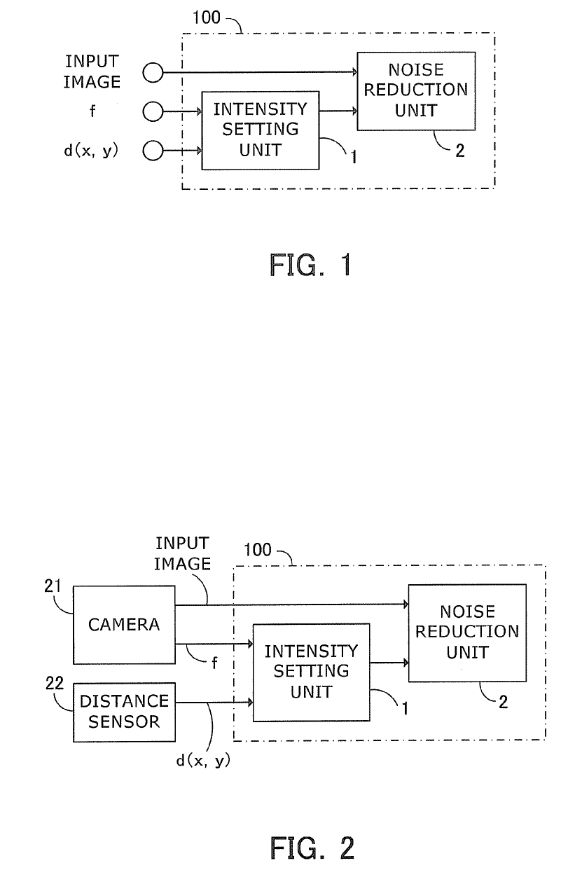

FIG. 1 is a block diagram of an image processing apparatus 100 according to a first embodiment. The image processing apparatus 100 receives an input image, a focus position f, and a depth map d (x, y). The image processing apparatus 100 reduces noise in the input image with an intensity corresponding to a difference between the focus position f and an object distance.

The input image is obtained by capturing an object with a camera (not shown) and includes a plurality of pixels arranged in x (horizontal) direction and y (vertical) direction. The focus position f represents a focus position of the camera during capturing, that is, a distance between the camera and a focus point.

The depth map d (x, y) is also referred to as a distance image. The depth map d (x, y) represents a depth value of a pixel at a position (x, y) (hereinafter merely referred to as pixel (x, y)). That is, the depth map d (x, y) represents a distance between the object and the camera at the pixel (x, y) (hereinafter merely referred to as an object distance). Specifically, each value of the depth map d (x, y) takes any value from 0 to 255. The object distance is shorter as the value becomes smaller.

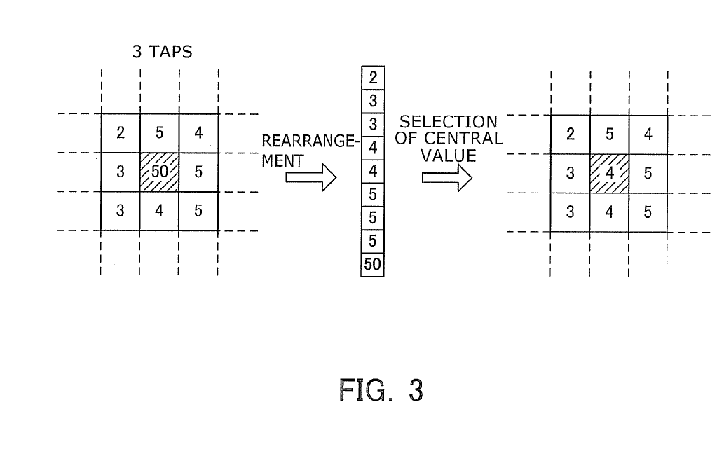

In the present embodiment, the image processing apparatus 100 receives the input image, the focus position f, and the depth map d (x, y), from the outside. For example, as illustrated in an image processing system of FIG. 2, the image processing apparatus 100 may receive the input image and the focus position f from a camera 21. The image processing apparatus 100 may receive the depth map d (x, y) from a distance sensor 22 using, for example, infrared light.

The image processing apparatus 100 includes an intensity setting unit 1 and a noise reduction unit 2. The intensity setting unit 1 calculates a difference between the focus position f and the object distance for each pixel (x, y). That is, a difference between the focus position f and the depth map d (x, y) is calculated. When an absolute value of the difference is small, an in-focus condition is indicated. When the absolute value of the difference is large, an out-of-focus condition is indicated. The intensity setting unit 1 sets the intensity of noise reduction for a pixel (x, y) based on the calculated difference. Specifically, the intensity setting unit 1 sets the intensity stronger as the absolute value of the difference increases. The noise reduction unit 2 reduces noise for each pixel with the set intensity.

The noise reduction processing is performed, for example, for luminance and colors. For example, the noise reduction unit 2 reduces noise using a median filter.

FIG. 3 is an explanatory diagram illustrating how the noise reduction is performed using a median filter. First, the intensity setting unit 1 sets the number of taps for pixels which are subjected to noise reduction. The noise reduction unit 2 then takes out pixel values in a range corresponding to the number of taps set above, around the pixel to be objected to noise reduction. The noise reduction unit 2 rearranges the pixel values taken out above in ascending order. The noise reduction unit 2 outputs a median of the rearranged pixel values as a pixel value after the noise reduction is performed.

In an example illustrated in FIG. 3, the number of taps is 3. The noise reduction unit 2 takes out the values of 3×3=9 pixels around the pixel subjected to noise reduction to rearrange the pixels in ascending order. Among the pixel values taken out above, the noise reduction unit 2 selects a value “4”, which is located in the 5th pixel, as the median. This processing is performed for all pixels in order of performing raster scan.

Such processing may be repeated by the noise reduction unit 2. The intensity of the noise reduction is stronger as the number of times of processing increases. Therefore, the intensity setting unit 1 may increase the number of times of performing the noise reduction as the absolute value of a difference between the focus position f and the depth map d (x, y) increases. The intensity of noise reduction can be stronger as the absolute value of the difference increases, that is, the intensity of noise reduction in the pixel can be stronger as the degree of the out of focus in the pixel increases.

The intensity of noise reduction also becomes stronger as the number of taps increases. Thus, the intensity setting unit 1 may variably set the number of taps for each pixel. An example of setting the number of taps will be described below. First, the intensity setting unit 1 calculates a radius r (x, y) of the tap based on the equation (1) below.

r(x, y)=|f−d(x, y)|/k (1)

where k represents a predetermined constant. The intensity setting unit 1 then sets the number of taps R (x, y) of the pixel (x, y) based on the equation (2) below.

R(x, y)=2*r(x, y)+1 (2)

The number of taps is set larger as the absolute value of the difference between the focus position f and the object distance d (x, y) increases.

Meanwhile, it is also possible to set the number of taps by using other methods such as a method using a look-up table where the relation between the absolute value of the difference and the number of taps has been set previously.

The reduction of noise may also be performed by the noise reduction unit 2 by any method capable of adjusting the intensity, other than the noise reduction using the median filter. When the input image includes luminance components and color components, the noise reduction unit 2 may perform the noise reduction for the luminance components alone to reduce the processing amount. This is because the noise of the luminance components stands out more easily.

As described above, in the first embodiment, the intensity of the noise reduction is set stronger as the absolute value of the difference between the focus position f and the object increases. Accordingly, the noise reduction can be performed with an appropriate intensity in such a manner that a strong intensity is applied to the pixels being out of focus and a weak intensity is applied to the pixels being in focus.

### SECOND EMBODIMENT

In the example of the first embodiment described above, the image processing apparatus 100 configured to receive the depth map d (x, y) from the outside has been described. In contrast, a second embodiment described below illustrates an image processing apparatus configured to generate the depth map d (x, y) by itself.

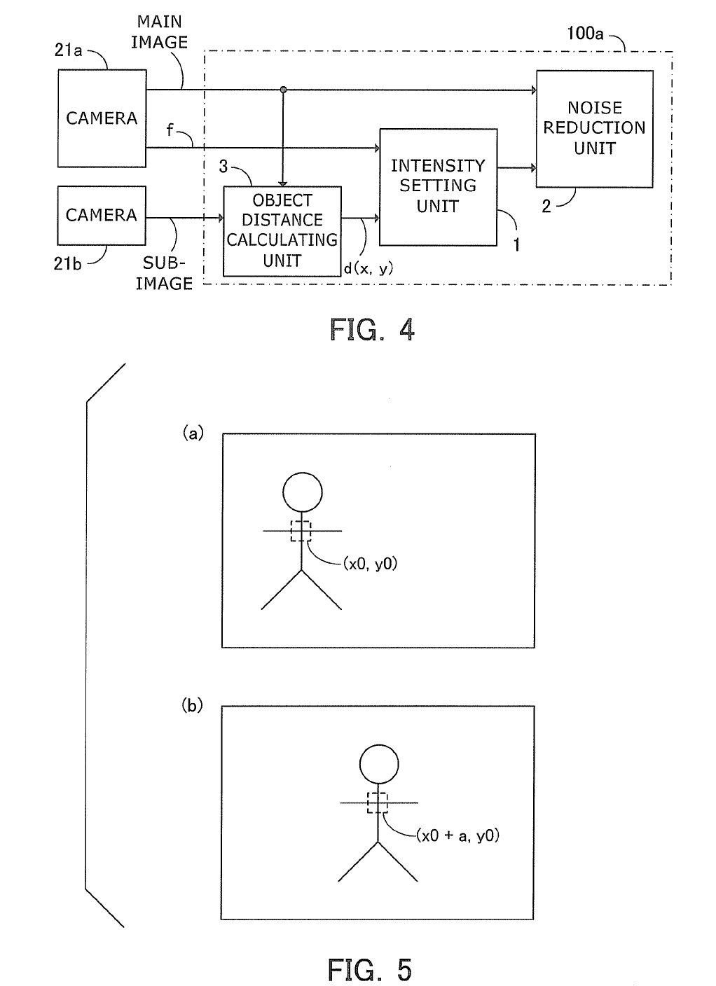

FIG. 4 is a block diagram illustrating an image processing system according to the second embodiment. In FIG. 4, the constituent elements similar to those in FIG. 2 are indicated by the same reference signs, and the following description will focus on the difference between those drawings.

The image processing system includes cameras 21a, 21b. The camera 21a captures an object to generate a main image (first image). The camera 21b captures the object from a position different from that of the camera 21a to generate a sub-image (second image). That is, the main image and the sub-image are taken from different viewpoints. The number of pixels of the sub-image may be the same as the pixels of the main image. Alternatively, the pixels of the sub-image may be smaller than the number of pixels of the main image.

An image processing apparatus 100a of the image processing system in FIG. 4 further includes an object distance calculating unit 3. The object distance calculating unit 3 searches corresponding points between the main image and the sub-image to generate the depth map d (x, y). Specifically, the object distance calculating unit 3 calculates an object distance z (=k/d) based on a distance d (parallax pixel) between a particular pixel (x0, y0) in the main image and a pixel (x0′, y0′) in the sub-image corresponding to the pixel (x0, y0).

FIG. 5 is an explanatory view illustrating the processing in the object distance calculating unit 3. It is assumed, for example, that a pixel (x0, y0) in the main image corresponds to a pixel (x0+a, y0) in the sub-image, as a result of searching corresponding points by the object distance calculating unit 3. In this case, the distance between corresponding pixels is a. The object distance calculating unit 3 then determines the depth map d (x0, y0) based on the distance a.

The object distance z can be uniquely determined from the distance d between the corresponding pixels. The object distance z is smaller as the distance d increases. Thus, the object distance calculating unit 3 may determine the depth map d (x0, y0) by performing predetermined conversion against the distance between the corresponding pixels, or may use that distance itself as the depth map d (x0, d0).

The search for the corresponding points may be performed by a known method. For example, the object distance calculating unit 3 sets a block around a pixel (x0, y0) to be searched in the main image. The object distance calculating unit 3 then calculates a sum of absolute values of the difference between the pixels of the block set above and the pixels in the block having the same number of pixels of the sub-image. The object distance calculating unit 3 searches a block in the sub-image where the sum of the absolute values of the difference is minimized. A pixel located in the center of the block minimizing the sum of absolute values of the difference is regarded as a point (x0′, y0′) corresponding the pixel (x0, y0).

As described above, in the second embodiment, the image processing apparatus 100a generates the depth map d (x, y) by itself. Therefore, even when the depth map d (x, y) is not input from the outside, the noise reduction can be performed with an appropriate intensity.

In the description of the embodiment above, the pixels have been separated from each other in a horizontal direction. However, it is also possible to determine the depth map d (x0, y0) by considering the case where the pixels are separated from each other in a vertical direction.

### THIRD EMBODIMENT

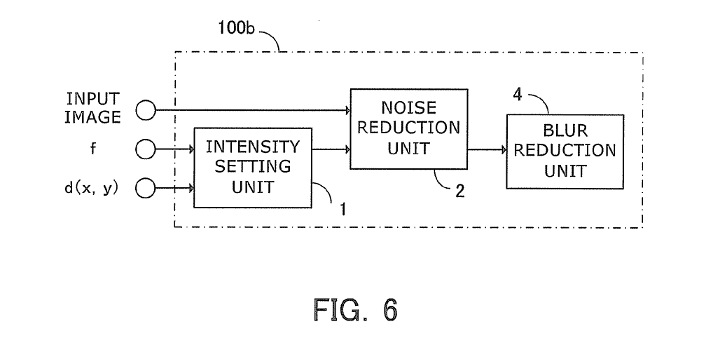

In the third embodiment, a blur is reduced after reduction of noise. The following description will focus on the difference between the first and third embodiments. FIG. 6 is a block diagram illustrating an image processing apparatus 100b according to the third embodiment. The image processing apparatus 100b further includes a blur reduction unit 4.

The blur reduction unit 4 performs blur reduction processing (an edge enhancement or a resolution restoration) of the images after noise reduction has been performed. If the reduction of blurs is performed before reduction noise, the noise is also emphasized to generate ringing. In this embodiment, therefore, the blur reduction unit 4 is provided in the rear stage of the noise reduction unit 2. The noise reduction unit 2 in the present embodiment can reduce noise with an appropriate intensity according to a difference between the focus position f and the object distance. Therefore, the blur reduction unit is able to reduce blurs against the images after the noise has been reduced. As a result, the image processing apparatus 100b can output high definition images having little noise and a feel of high resolution.

The blur reduction unit 4 may also be provided in the image processing apparatus 100a of the second embodiment.

At least a portion of the image processing system described in the above embodiments may be constituted by hardware or software. In the software configuration, a program realizing at least a portion of the functions of the image processing system is stored in a recording medium such as a flexible disk or a CD-ROM and may be read by a computer to be executed thereby. The storage medium is not limited to a detachable one such as a magnetic disk and an optical disk and may be a stationary recording medium such as a hard disk device and a memory.

Furthermore, the program realizing at least a portion of the image processing system may be distributed through a communication line (including wireless communication) such as the Internet. While the program is encrypted, modulated, or compressed, the program may be distributed through a wired line or a wireless line such as the Internet, or the program stored in a recording medium may be distributed.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. An image processing apparatus configured to perform noise reduction of a first image obtained by capturing an object by an image capturing device, comprising:
an intensity setting unit configured to set intensity of noise reduction based on a focus position of the image capturing device during capturing of the object and an object distance between the image capturing device and the object; and
a noise reduction unit configured to perform noise reduction of the first image with the set intensity of the noise reduction.

2. The image processing apparatus according to claim 1, wherein
the intensity setting unit sets the intensity of the noise reduction based on a difference between the focus position and the object distance.

3. The image processing apparatus according to claim 2, wherein
the intensity setting unit sets a larger intensity of the noise reduction as an absolute value of the difference increases.

4. The image processing apparatus according to claim 1, wherein
the intensity setting unit sets the intensity of the noise reduction for each pixel of the first image, and
the noise reduction unit performs the noise reduction for each pixel with the set intensity of the noise reduction for each pixel.

5. The image processing apparatus according to claim 1, wherein
the noise reduction unit performs the noise reduction using a median filter.

6. The image processing apparatus according to claim 5, wherein
the intensity setting unit sets a larger number of taps of the median filter as an absolute value of the difference between the focus position and the object distance increases, and
the noise reduction unit performs the noise reduction using the median filter having the set number of taps.

7. The image processing apparatus according to claim 5, wherein
the intensity setting unit sets a larger number of times of repetition of the noise reduction using the median filter as an absolute value of the difference between the focus position and the object distance increases, and
the noise reduction unit performs the noise reduction using the median filter for the set number of times of repetition.

8. The image processing apparatus according to claim 1, further comprising:
an object distance calculating unit configured to calculate the object distance from the first image and a second image, the second image being captured from a view point different from the view point of the first image.

9. The image processing apparatus according to claim 1, further comprising:
a blur reduction unit configured to perform blur reduction of an image after the noise reduction has been performed.

10. An image processing system, comprising:
a first image capturing device configured to obtain a first image by capturing an object;
a second image capturing device configured to obtain a second image by capturing the object from a viewpoint different from a viewpoint of the first image capturing device;
an object distance calculating unit configured to calculate an object distance between the first image capturing device and the object, from the first image and the second image;
an intensity setting unit configured to set intensity of noise reduction based on a focus position of the first image capturing device during capturing of the object and the object distance; and
a noise reduction unit configured to perform noise reduction of the first image with the set intensity of the noise reduction.

11. The image processing system according to claim 10, wherein
the intensity setting unit sets the intensity of the noise reduction based on a difference between the focus position and the object distance.

12. The image processing system according to claim 11, wherein
the intensity setting unit sets a larger intensity of the noise reduction as an absolute value of the difference increases.

13. The image processing system according to claim 10, wherein
the intensity setting unit sets the intensity of the noise reduction for each pixel of the first image, and
the noise reduction unit performs the noise reduction for each pixel with the set intensity of the noise reduction for each pixel.

14. The image processing system according to claim 10, wherein
the noise reduction unit performs the noise reduction using a median filter.

15. The image processing system according to claim 14, wherein
the intensity setting unit sets a larger number of taps of the median filter as an absolute value of the difference between the focus position and the object distance increases, and
the noise reduction unit performs the noise reduction using the median filter having the set number of taps.

16. The image processing system according to claim 14, wherein
the intensity setting unit sets a larger number of times of repetition of the noise reduction using the median filter as an absolute value of the difference between the focus position and the object distance increases, and
the noise reduction unit performs the noise reduction using the median filter for the set number of times of repetition.

17. The image processing system according to claim 10, further comprising:
a blur reduction unit configured to perform blur reduction of an image after the noise reduction has been performed.

18. An image processing method configured to perform noise reduction of a first image obtained by capturing an object by an image capturing device, comprising:
setting intensity of noise reduction based on a focus position of the image capturing device during capturing of the object and an object distance between the image capturing device and the object; and
performing the noise reduction of the first image with the set intensity of the noise reduction.

19. The image processing method according to claim 18, wherein
in the setting the intensity of the noise reduction, the intensity of the noise reduction is set based on a difference between the focus position and the object distance.

20. The image processing method according to claim 19, wherein
in the setting the intensity of the noise reduction, a larger intensity of the noise reduction is set as an absolute value of the difference increases.
